(19) United States
(12) Patent Application Publication
(10) Pub. No.: US 2017/0004508 A1
(43) Pub. Date: Jan. 5, 2017

(54) SYSTEMS AND METHODS FOR EFFICIENTLY HANDLING APPLIANCE WARRANTY SERVICE EVENTS

(71) Applicant: Cross Country Home Services, Inc., Fort Lauderdale, FL (US)

(72) Inventors: Stephen K. Mansfield, Wellington, FL (US); Zachary Rote, Miramar, FL (US); Leah Page, Fort Lauderdale, FL (US); Jay Darfler, Fort Lauderdale, FL (US); Jason Carter, Davie, FL (US)

(21) Appl. No.: 15/197,122

(22) Filed: Jun. 29, 2016

Related U.S. Application Data
(60) Provisional application No. 62/187,006, filed on Jun. 30, 2015.

(51) Int. Cl. G06Q 30/00; H04L 12/28

(52) U.S. Cl. CPC G06Q 30/012; H04L 12/2827; H04L 12/2825

(57) ABSTRACT

An automated event management system for smart appliances residing at locations of owners and communicatively connected to respective smart-appliance event-reporting platforms includes a service response platform and an enterprise resource platform. The service response platform receives appliance event messages from respective ones of the smart appliances and normalizes them into outbound service call requests having a standardized format and determines an appropriate responsive action to the outbound service call request by accessing data including past information and performing a triage to determine root failures. Based upon the determination a trade and replacement parts are selected. After repair information is gathered to diagnose that repair and improve the data for future use. The enterprise resource platform manages the service providers by scheduling service calls directly in calendars, by dispatching the providers, by selecting replacement parts and communicating with the owners regarding the service call, and by transmitting the service call data.

### CROSS-REFERENCE TO RELATED APPLICATIONS

This application claims the priority, under 35 U.S.C. §119, of copending U.S. Provisional Patent Application No. 62/187,006, filed Jun. 30, 2015, the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present systems, apparatuses, and methods lie in the fields of warranty service repair and fee-for-service repairs. The present disclosure relates to an integrated technology and business process for quickly and efficiently handling home appliance service events.

### BACKGROUND OF THE INVENTION

An automated repair model provides a method for automatic diagnosis and repair of appliances. If an appliance fails or begins to operate outside of nominal behavior, the appliance automatically notifies the automated service provider, who then determines the failure and dispatches a service technician skilled in the necessary repair trade. The benefits for this service are fast and accurate measures of identifying an appliance failure, an ability to determine a root failure before a tradesman is sent to the home, and a quick dispatch of a service technician.

The automated repair model utilizes Internet of Things (IoT) technology and an automated triage, scheduling, and dispatch technology to manage the service events. The automated repair model described herein is capable of servicing both warranty and fee-for-service business models. As used herein, “warranty services” is defined as a business model where a customer pays a monthly premium as insurance against a costly repair, and “fee-for-service” is defined as a business model where a customer pays for a service event at the time the service is rendered (which does not preclude use of any of a variety of financing plans that may be available to the customer). As used herein, warranty services and fee-for-service repairs are interchangeable and can be generally called “contract services” or “automated contract services.” “Contract services,” when used, refers to a manual fee-for-service or warranty service. This is in contrast to “automated contract services,” which refers to the technology described herein and covering both automated fee-for-service and automated warranty service.

Diagnosis and correct repair can be quite complex. In typical appliance failure situations, analysis of root failure of the appliance cannot be done until a repairperson actually is present at the location of the appliance. Then, when diagnosed, the needed replacement parts are typically not with the repairperson, requiring a wait for the replacement part and a subsequent return of the repairperson to the location. During this time, the customer may be entirely unaware of the status of the repair, leading to customer dissatisfaction and frustration. Managing service is also costly when a contract administrator needs to send a repairperson to the location more than once. This results in an increase in the cost of managing such services, which increases the cost of the repair and the cost of the businesses that manage service events. All of this erodes and damages the overall service experience by the customer.

The current state of the art does not offer automated service management. An example of a typical process flow is depicted in FIG. 1. When an appliance breaks down, the customer 10 calls into a customer service agency 20. The customer 10 provides an amount of information for the customer service call center 22 to use in determining the root failure and setting up a service request 26, and then to dispatch a correct repair tradesperson 32. Many customers 10 have little knowledge of the details of the appliance 12 that has failed. Thus, a service representative 24 of the service agency call center 22 must ask the customer 10 a series of questions in an attempt to determine the root failure of the appliance 12. Once the service representative 24 has asked questions sufficient to determine which tradesperson 32 to dispatch, the service representative 24 then selects an appropriate service company 30 near the customer 10 and schedules a service call 34. The service representative 24 then calls the customer 10 back to confirm the scheduled service call 34. Often, the service company 30 must make more than one service call 34 because the problem was misdiagnosed initially. Either the wrong tradesperson 32 shows up (e.g., a Heating, Ventilation, and Air Conditioning (HVAC) technician arrives when an electrician was needed), or the tradesperson 32 did not have the correct replacement parts. This takes a lot of time on the part of all involved and is frustrating for the customer 10, who wants their appliance 12 fixed quickly. When the service request 26 is completed, the service representative 24 must then confirm with the customer 10 that the work order was completed successfully and determine if the customer 10 is satisfied. If not, the service representative 24 must recall the service company 30 to correct any issues with the service work order.

Based upon the required steps within the workflow of a service request, the typical workflow is time-consuming. It is highly dependent upon the customer service agency correctly orchestrating the workflow manually. Customer awareness of the details of the appliance failure is also critical. Customers are often ill-prepared to help diagnose appliance failures, resulting in an incorrect appliance diagnosis and the resultant added time, steps, and inefficiencies. In particular, misdiagnosis leads to multiple service calls and can be very frustrating to the customer. In the end, multiple service calls increase the cost to handle the service event. These costs are all passed on to the customer. Thus, a need exists to overcome the problems with the prior art systems, designs, and processes as discussed above.

### SUMMARY OF THE INVENTION

The systems, apparatuses, and methods described provide for efficient handling of home appliance service events that overcome the herein aforementioned disadvantages of the current state of the art and provide such features with a fast and accurate processing of appliance warranty contracts and fast servicing of appliance service events.

The systems, apparatuses, and methods described herein utilize Internet of Things (IoT) technology to detect and determine an appliance failure. When an appliance failure event is triggered, a cloud-based Enterprise Resource Platform (ERP) system is used to manage the overall status and selection of the service provider. A cloud-computing facility utilizing machine-learning technology analyzes the error codes associated with the appliance failure and creates a series of dynamically generated triage questions that are presented to the customer via a smartphone application (in one example embodiment). After the customer answers the questions, the cloud service determines the correct actions needed to service the appliance failure. An appliance service organization is automatically notified and scheduled by the cloud service and the customer is notified of that scheduling.

The systems, apparatuses, and methods described herein include four major components. First, one or more appliances contain hardware, software, and firmware that have the ability to monitor their own state and/or efficiency, and have the ability to report their status through a computer network to an online system that may store the history of that appliance's statuses in a database, and may further provide such information to authorized third parties.

Second, an implementation of a Service Response Platform (SRP) is provided. The SRP is composed of three primary software components: an Event Normalizer (EN), a Service Response Platform Engine (SRPE) and a Machine Learning Service Engine (MLSE). The EN is capable of consuming statuses from the aforementioned smart appliances (through one or more of the aforementioned online services) and converting them into a common format, a process referred to herein as “Normalization.” After Normalization, the EN forwards the appliance status to the Service Response Platform Engine (SRPE), which is the software and hardware implementation of an automated repair service platform. The SRPE takes input from the EN and, depending on the particular status reported by the smart appliance, the SRPE may take several actions, which may include but are not limited to: sending messages to the customer (through a smartphone application, in one example embodiment), pushing requests for repair service to an Enterprise Resource Platform (ERP), or requesting the MLSE to analyze an appliance status. The MLSE is an artificial intelligence program that progressively learns the best corrective actions to take for any appliance failure incident by comparing the current status with archived information about appliance failure causes and triage question answers. In this way, as the overall system operates over time, the MLSE is capable of providing accurate and targeted information to service professionals.

Third, the Enterprise Resource Platform (ERP) is a service request engine and is composed of two components, a Dynamic Vendor Rating (DVR) engine and a Customer and Service Provider Management platform (CSPM). The DVR engine uses historical information about service providers' performance across a variety of metrics (configurable via adjustable weighting factors) to select the best available service provider that services a territory which includes the customer's home/business/location. CSPM is a system that manages all activities related to a specific customer service event, such as dispatching a service provider, updating the service provider calendar, providing status updates to the homeowner, etc. The ERP takes its input from the SRPE. These events are passed on to CSPM and all actions are recorded in its database. If a service call is requested, CSPM requests the DVR engine to select a service provider. Once a service provider is selected, CSPM contacts the service provider to notify them of the service appointment (through any of several methods, including but not limited to phone calls, messaging to a smartphone application, or placing an appointment on the service provider's calendar).

With the foregoing and other objects in view, there is provided, an automated event management system for smart appliances residing at locations of owners and communicatively connected to respective smart-appliance event-reporting platforms, the system comprising a service response platform and an enterprise resource platform. The service response platform is communicatively connected to the smart-appliance event-reporting platforms that receive manufacturer-specific appliance event messages from respective ones of the smart appliances. The service response platform normalizes received manufacturer-specific appliance event messages to determine an outbound service call request having a standardized format. The service response platform is communicatively connected to smartphones of the owners and sending at least one message with a service response platform engine to an owner's smartphone, the message having content dependent upon the determined outbound service call request. The service response platform determines an appropriate responsive action to the outbound service call request by accessing a database of best corrective actions for each outbound service call request, performing a triage process to determine a root failure of an appliance associated with the outbound service call request, based upon the determined root failure selecting a relevant trade to be dispatched from a set of trades, selecting replacement parts needed, and estimating service time. The service response platform receives service call completion information after the outbound service call request has been performed and diagnoses and compares the received service call completion information within the triage process and storing within the database comparison information to permit improved future handling of incidents based upon that comparison. The enterprise resource platform is communicatively coupled to the service response platform and to calendars of a plurality of service providers in the set of trades. The enterprise resource platform receives, from the service response platform, the outbound service call request, the selected trade to be dispatched, and the replacement parts, selects a service provider within the selected trade, examines a calendar of the selected service provider, and, based upon examination of the calendar, schedules a physical service call to require a representative of the selected service provider to perform service on the appliance at the location of the owner at a given date and time and to have the representative bring the replacement parts to the location during the service call, informs the service response platform engine of details regarding the service call to, thereby, notify the owner that the service call is pending and to inform the owner of a name of the service provider, a name of the representative to be arriving, and the given date and time of the service call, and receives service call completion information from the service provider, closing the service call, and sending a request to the service response platform to notify the owner that the service call has been completed.

With the objects in view, there is also provided a method of handling appliance service events including the steps of sending an Internet-based message from a smart appliance to at least one cloud-based smart-appliance event-reporting platform when a failure of the appliance occurs, forwarding a manufacturer-specific appliance event message from the smart-appliance event-reporting platform to a service response platform, evaluating the failure of the appliance with the service response platform dependent upon manufacturer-specific appliance event message by normalizing the manufacturer-specific appliance event message to determine an outbound service call request having a standardized format accessing a database of best corrective actions for the outbound service call request, performing a triage process to determine a root failure of the appliance and, based upon the determined root failure selecting a relevant trade to be dispatched from a set of trades and selecting replacement parts needed, receiving service call completion information after the outbound service call request has been performed, and diagnosing and comparing the received service call completion information within the triage process and storing within the database comparison information to permit improved future handling of incidents based upon that comparison, communicating with the owner through the owner's smartphone to obtain information regarding the appliance to better understand and diagnose the failure, determining a service action to take based upon the outbound service call request and information from the owner, when a service call is determined to be required, with an enterprise resource platform, examining calendars of at least one service provider in the set of trades, and, based upon examination of the calendar, selecting a service provider within the trade and scheduling a physical service call to require a representative of the selected service provider to perform service on the appliance at the location of the owner at a given date and time and to have the representative bring the replacement parts to the location during the service call, informing service response platform of details regarding the service call to, thereby, notify the owner that the service call is pending and to inform the owner of a name of the service provider, a name of the representative to be arriving, and the given date and time of the service call, and, when a service call is completed receiving service call completion information from the service provider at the enterprise resource platform, closing the service call at the enterprise resource platform, sending a request from the enterprise resource platform to the service response platform to notify the owner that the service call has been completed, and sending information about the service call from the enterprise resource platform to the service response platform to be added to the database of best corrective actions for determining at least one of accuracy of a diagnosis the failure of the appliance and to add knowledge to the database for improving future failure diagnoses.

In accordance with another feature, the service response platform has an event normalizer normalizing the received manufacturer-specific appliance event messages and determining therefrom the outbound service call request in the standardized format.

In accordance with a further feature, the service response platform engine has a system monitor comprising a web-based dashboard, a service response engine hosting a database of service instances each being able to be viewed from the system monitor, a load balancer interfacing with the service response engine to access the service instances, and a worker object factory associated with each service instance.

In accordance with an added feature, the smart-appliance event-reporting platforms receive manufacturer-specific appliance event messages from respective ones of the smart appliances when the one smart appliance has a failure incident.

In accordance with an additional feature, the service response platform has a machine learning service engine that hosts the database of best corrective actions and progressively learns a best corrective action for each appliance failure incident by accessing the database of best corrective actions for each outbound service call request, performing the triage process to determine a root failure of an appliance associated with the outbound service call request, based upon the determined root failure selecting the relevant trade to be dispatched from the set of trades, selecting the replacement parts needed, and estimating the service time, receiving the service call completion information after the outbound service call request has been performed, and diagnosing and comparing the received service call completion information within the triage process and storing within the database comparison information to permit improved future handling of incidents based upon that comparison.

In accordance with yet another feature, the enterprise resource platform has a customer and service provider manager configured to manage all accounts of the owners, to track all service events, and to output service provider requests, communicatively connected to the calendars of the service providers and, through this connection, is operable to set the service call within the calendar of any of the service providers, and communicatively connected to the service response platform engine to exchange information regarding the service call and to have service response platform engine notify the owner that the service call is pending and to send the name of the service provider, the name of the representative to be arriving, and the date and time of the service call.

In accordance with yet a further feature, the service response platform engine notifies the owner through at least one of the smartphone and an email.

In accordance with yet an added feature, the enterprise resource platform has a dynamic vendor rating engine configured to receive the service provider requests from the customer and service provider manager, to select a set of highest rated service providers located near the location of the owner of the appliance to be serviced, and to rank the service providers based on parameters comprising at least one of service response time, customer input, lowest cost, and fewest callbacks.

In accordance with yet an additional feature, the customer and service provider manager receives the service call completion information from the service provider, closes the service event, and sends the request to the service response platform engine to notify the owner that the service call has been completed.

In accordance with again another feature, the customer and service provider manager receives the service call completion information from the service provider through at least one of the smartphone and an email.

In accordance with again a further feature, the service response platform is a server communicatively connected to the Internet.

In accordance with again an added feature, the service response platform provides a direct interface to an owner's smartphone and pushes service calls to the enterprise resource platform.

In accordance with again an additional feature, the smart-appliance event-reporting platforms comprise at least one server communicatively connected to the Internet.

In accordance with still another feature, there is provided a plurality of replacement parts and a plurality of service providers each being associated with at least one of the set of trades and each having a name, at least one of the calendars, at least one service representative, and a communication device configured to at least one of receive the service call and send the service call completion information.

In accordance with still a further feature, the plurality of replacement parts is located at a central location.

In accordance with a concomitant feature, a sub-set of the plurality of replacement parts is located at each of the service providers.

The systems, apparatuses, and methods described herein for providing service allow for fast and accurate diagnosis of appliance failures, allow for improvement in root failure analysis of the appliance, quick dispatch of the correct repair service tradesperson, provide instant and continuous communication with customers regarding the status of the service event, permit timely tracking of the progress of the service event with devices that are easy to use by the customer, and provide the ability to measure overall customer effectiveness of the service. The systems, apparatuses, and methods described improve the speed, convenience, accuracy, and traceability of a service event. The systems, apparatuses, and methods lower the cost of managing repair services, thereby decreasing monthly premiums and overall repair costs, which improves the overall service that the customer receives. Many steps of the manual processes previously employed are eliminated, thus reducing the cost and improving the speed and accuracy of each service event.

Novel features of the herein-described systems, apparatuses, and methods include the overall software architecture, the end-to-end digital service experience, the Event Normalizer (EN), the Service Response Platform Engine (SRPE), the Machine Learning Service Engine (MLSE), the Customer and Service Provider Management platform (CSPM), the Dynamic Vendor Rating (DVR) engine, and an automated service call dispatch, to name a few.

Although the systems, apparatuses, and methods are illustrated and described herein as systems, apparatuses, and methods for efficiently handling home appliance warranty and fee-for-service events, they are, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and/or methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a diagram of a prior art appliance service process flow;

FIG. 2 is a diagram of an exemplary embodiment of an automated contract services event management system and methods for providing automated contract services event management;

FIG. 3 is a block diagram of a service response platform engine for the system and methods of FIG. 2; and

FIG. 4 is a flow diagram of an exemplary embodiment of a process for handling appliance faults with the automated contract services event management system and methods of same.

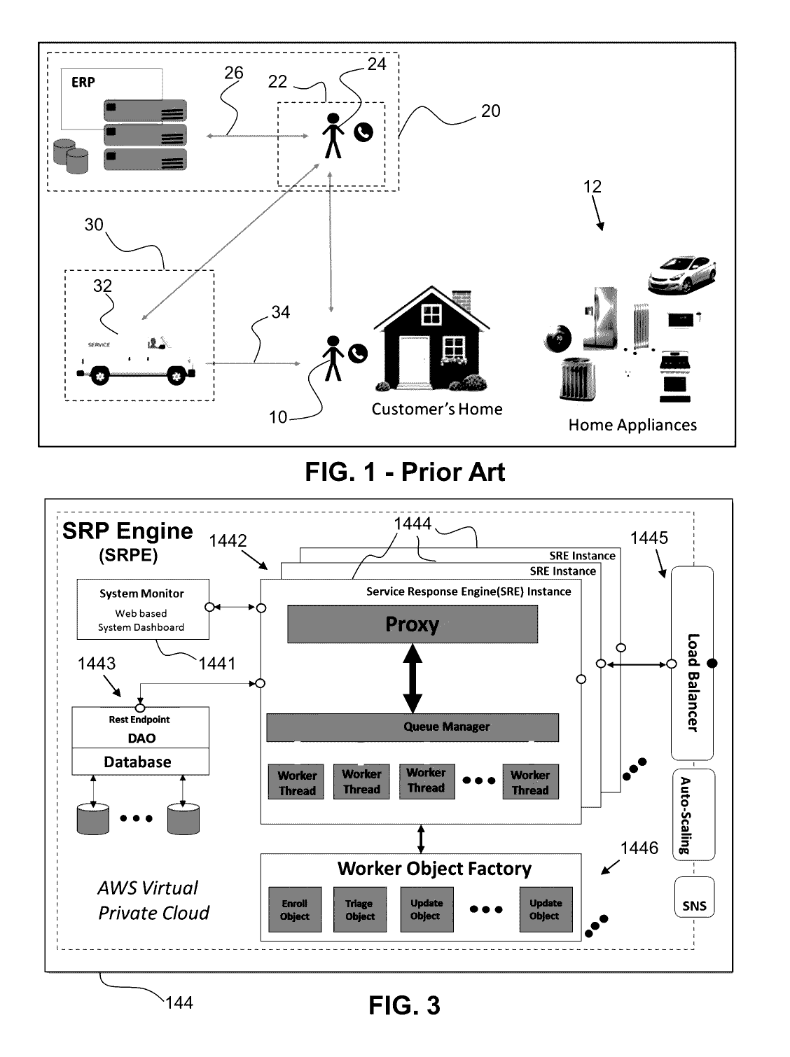

### DETAILED DESCRIPTION OF THE INVENTION

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, and top/bottom. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

It will be appreciated that embodiments of the systems, apparatuses, and methods described herein may be comprised of one or more conventional processors and unique stored program instructions that control the one or more processors to implement, in conjunction with certain non-processor circuits and other elements, some, most, or all of the functions of the devices and methods described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system or programmable device. A “program,” “software,” “application,” “computer program,” or “software application” may include a subroutine, a function, a procedure, an object method, an object implementation, an executable application, an applet, a servlet, a source code, an object code, any computer language logic, a shared library/dynamic load library and/or other sequence of instructions designed for execution on a computer system.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

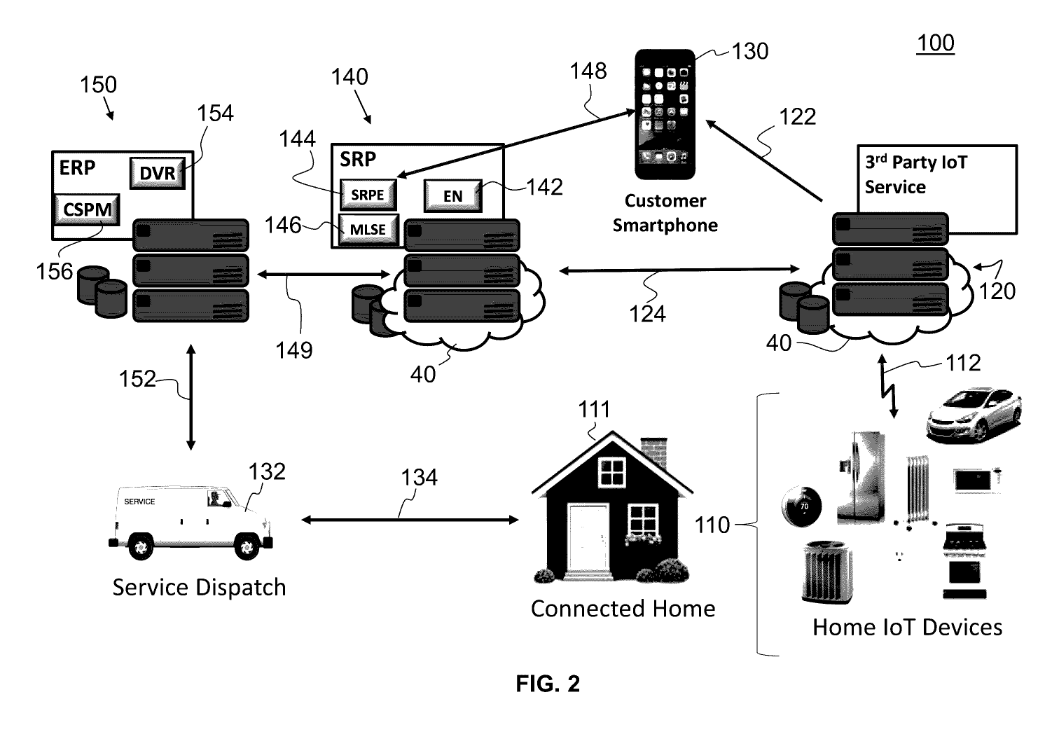

Described now are exemplary embodiments. Referring now to the figures of the drawings in detail and first, particularly to FIG. 2, there is shown an exemplary embodiment of an automated contract services event management system and methods for providing automated contract services event management, hereinafter referred to as EMS 100.

With regard to event management of automated contract services, it is beneficial to first understand Internet of Things (IoT) or “Smart” appliances 110.

Manufacturers are including automated monitoring and status reporting functionality in their appliance products 110. Homeowners 111 who purchase these appliances 110 can connect them to the Internet 40. The Internet 40 is diagrammatically indicated by clouds within FIG. 2. The appliance may contain one or more communication devices (e.g., radios) that support, for example, ZigBee, ZWave, Bluetooth, and WiFi (802.11) protocols, thereby allowing for communication through the Internet 40 (possibly via a router and/or communication hub) to manufacturers and service providers, for example. The appliances 110 send out messages 112 using one or more of these radio protocols. The messages 112 contain the status of the respective appliance's operation and include diagnostic information when the product fails. In a particular communications example, the operation/diagnostic messages from the appliance 110 may be bundled into TCP/IP packets and sent over the Internet 40 (possibly via a router or communication hub) to a cloud-based server, which can be hosted by a manufacturer or third party. As such, each manufacturer of an appliance 110 can have its own format for sending such messages. The lack of standards or compliance requirements for such communications increases the complexity for operating the EMS 100 under such circumstances. Either all of such communication is stored within the EMS 100 for parsing and diagnosing or, in an exemplary embodiment, the EMS 100 includes a common set of diagnostic and information codes for each type of appliance 110 (e.g., thermostat, refrigerator, A/C unit, microwave, stove). In one exemplary embodiment, within the coded message is the Original Equipment Manufacturer (OEM) code, the Original Device Manufacturer (ODM) code, the appliance part number, the engineering change number, the option number, the date of manufacture, the software/firmware release, the machine failure code, the number of operational hours, and the current time.

When an event occurs in the Smart Appliance, a cloud-based event-reporting platform 120 provided by the device manufacturer/third party is the receiver of the device's status. This platform 120 may then notify the homeowner via a smartphone message 122 and may also forward the event message 124 to the Service Response Platform 140 to process. All data transferred to the SRP 140 is validated and encrypted.

The SRP 140 is a cloud service that handles all requests from the manufacturer's cloud platform 120, provides a direct interface 148 to the user's smartphone 130, and pushes service calls/requests 149 to an Enterprise Resource Platform (ERP) 150 described below. The SRP 140, which handles all Smart Appliance 110 events and determines the appropriate actions, is composed of three major components: the Event Normalizer (EN) 142; the Service Response Platform Engine (SRPE) 144; and the Machine Learning Service Engine (MLSE) 146.

The function of the Event Normalizer 142 is to interpret the manufacturer-specific indications that are sent by the Smart Appliance 110 to the manufacturer's cloud 120 (and then forwarded to the SRP 140). It does this by encapsulating some or all of the information provided in that indication into a standard event format that can then be operated on in a common manner by the other components in the SRP 140. This process converts manufacturer-specific or device-specific indications into one common format, so that, for example, a refrigerator compressor failure is understood to be a compressor failure irrespective of: the manufacturer of the refrigerator; the manufacturer of the compressor unit in the refrigerator; the model number; or any of several other data values that may or may not be included in the indication sent by the Smart Appliance 110. The EN 142 will then provide this normalized indication to the Service Response Platform Engine (SRPE) 144 to process.

The SRPE 144 receives and handles all messages from the EN 142, handles messaging 148 to the homeowner's smartphone 130, and passes requests to the ERP 150 and the MLSE 146. The components of the SRPE 144 depicted in FIG. 3 include a system monitor 1441 that can have a web-based dashboard. A service response engine 1442 hosts a database 1443 of service instances 1444, each being able to be viewed from the system monitor 1441. A load balancer 1445 interfaces with the service response engine 1442 to access the service instances 1444. A worker object factory 1446 is associated with each service instance 1444.

The MLSE 146 is an artificial intelligence program that progressively learns the best corrective action(s) for any appliance failure incident. The MLSE 146 analyzes the message from the SRPE 144 and then performs a triage process to determine a root failure of the appliance 110. The MLSE 146 also determines the relevant trade to be dispatched, recommends replacement parts, and estimates service time. After the failure incident is diagnosed, information is provided back to the MLSE 146 to be compared with the triage process and to form a database that permits future handling of failure incidents based upon that comparison. In essence, as more events are handled, the MLSE 146 correctly diagnoses the faults and dispatches the correct tradesperson more often, resulting in a system that becomes more efficient as time goes on, thereby reducing the overall cost of handling automated contract services claims.

If the analysis performed by the SRP 140 determines that a service call 134 is required, then the SRP 140 will send a message 149 to the Enterprise Resource Platform (ERP) 150. The ERP 150 will then send a service request 152 to the appropriate service provider 132. The ERP 150 contains two key components, a Customer and Service Provider Manager (CSPM) 156, and a Dynamic Vendor Rating (DVR) engine 154. The CSPM 156 manages all of the customer accounts and tracks any service events handled by the system. The CSPM 156 also is the primary tool used by the service representatives of the EMS 100 to analyze account status and manage issues.

Each of the service providers 132 is associated with one or more of a set of trades (e.g., electrician, HVAC, plumber). Each of the service providers 132 has a name (which may or may not be unique) and its own calendar for scheduling service calls 134. Each of the service providers 132 has one or more service representatives, each having a name (which may or may not be unique) that is communicated when reporting a service call 134. Each of the service providers 132 has a communication system or device (e.g., radio, Internet connection) that is able to receive the service call 134 and/or send the service call completion information 152. The service providers 132 have access to all of the replacement parts needed to complete a service call 134. The replacement parts can be located at a central location or a relevant sub-set of the replacement parts is located at each of the service providers 132.

If a service call 134 has to be initiated, the CSPM 156 uses the DVR engine 154 to select a set of highest rated service providers 132 located near the homeowner's location. The DVR engine 154 constantly ranks service providers 132 based on various parameters including, for example, service response time, customer input, lowest cost, and fewest callbacks. The CSPM 156 is provided with access to calendars of the service providers 132 to prevent mis-scheduling of service calls 134. When a service provider 132 is selected by the DVR engine 154, the DVR engine 154 utilizes the CSPM 156 to check the service provider's calendar and schedules the service call 134 at an open time slot. The CSPM 156 informs the SRP 140 of the service call 134 and the SRP 140 notifies the homeowner 111 (e.g., through the smartphone 130 or through an email or other communication method) that a service call 134 is pending, along with a name of the service provider 132, a name of the technician to be arriving, and the date and time of the service call 134. Once the service provider 132 has completed the work, the service provider 132 updates the status of the service event (via a smartphone app, email, or other communication method) and the service event is then closed. The CSPM 156 also notifies the homeowner 111 that the work has been completed.

Each of the EN 142, the SRPE 144, the MLSE 146, and the communication by these systems with a homeowner's smartphone 130 is unique and does not exist in the prior art. Also novel is the interaction between the ERP 150 and the SRP 140. Finally, the ERP 150 and integration of the manufacturers' device service platforms 120 with a Service Response Platform (SRP) 140 does not exist in the prior art.

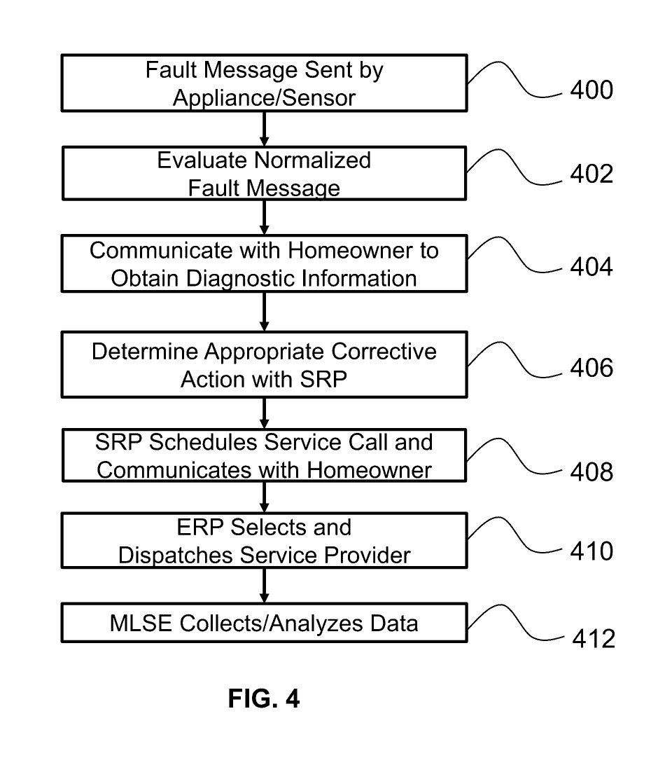

Flow of a service event is enabled with the EMS 100 by utilizing the IoT-enabled appliances 110 and is described with respect to the flow chart of FIG. 4. As set forth above, IoT is a connectivity-based technology where every appliance or device is monitored by an Internet-connected communications device (e.g., a microprocessor). When a failure occurs in Step 400, the appliance 110 sends an Internet-based message 112 to at least one cloud-based IoT server (e.g., server 120) that forwards the event to the SRP 140, which evaluates the error(s) in Step 402. These server(s) 120/140 utilize machine learning and interact 122/148 (through data or voice or a combination of communication measures) with the homeowner 111 in Step 404 through the customer's smartphone 130 to enable a better understanding of the situation for diagnosing the error. In Step 406, the server 140 determines the appropriate service action(s) to take based upon that information. When a service call 134 is appropriate, in Step 408, the server 140 schedules a service request/call 149, which in turn causes messages 148 to be sent to the homeowner 111 or the smartphone 130 and causes the ERP 150 to dispatch 152 the optimal service provider 132 in Step 410. After the service provider 132 repairs the appliance 110, all information about the repair is collected and analyzed by the MLSE 146 in Step 412, for example, to determine the accuracy of the diagnosis as well as add to its knowledge database for improving future repair diagnoses. All this is done in an automated fashion to expedite the workflow and accuracy of the service event.

The automated contract services management systems, apparatuses, and methods described dramatically improve the speed, traceability, convenience, and accuracy of the appliance service events.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined herein.

What is claimed is:

1. An automated event management system for smart appliances residing at locations of owners and communicatively connected to respective smart-appliance event-reporting platforms, the system comprising:
a service response platform:
communicatively connected to the smart-appliance event-reporting platforms that receive manufacturer-specific appliance event messages from respective ones of the smart appliances;
normalizing received manufacturer-specific appliance event messages to determine an outbound service call request having a standardized format;
communicatively connected to smartphones of the owners and sending at least one message with a service response platform engine to an owner's smartphone, the message having content dependent upon the determined outbound service call request; and
determining an appropriate responsive action to the outbound service call request by:
accessing a database of best corrective actions for each outbound service call request;
performing a triage process to determine a root failure of an appliance associated with the outbound service call request;
based upon the determined root failure:
selecting a relevant trade to be dispatched from a set of trades;
selecting replacement parts needed; and
estimating service time;
receiving service call completion information after the outbound service call request has been performed; and
diagnosing and comparing the received service call completion information within the triage process and storing within the database comparison information to permit improved future handling of incidents based upon that comparison; and
an enterprise resource platform:
communicatively coupled to the service response platform and to calendars of a plurality of service providers in the set of trades;
receiving, from the service response platform, the outbound service call request, the selected trade to be dispatched, and selected the replacement parts;
selecting a service provider within the selected trade, examining a calendar of the selected service provider, and, based upon examination of the calendar, scheduling a physical service call to require a representative of the selected service provider to perform service on the appliance at the location of the owner at a given date and time and to have the representative bring the replacement parts to the location during the service call;
informing the service response platform engine of details regarding the service call to, thereby, notify the owner that the service call is pending and to inform the owner of a name of the service provider, a name of the representative to be arriving, and the given date and time of the service call; and
receiving service call completion information from the service provider, closing the service call, and sending a request to the service response platform to notify the owner that the service call has been completed.

2. The system according to claim 1, wherein the service response platform has an event normalizer normalizing the received manufacturer-specific appliance event messages and determining therefrom the outbound service call request in the standardized format.

3. The system according to claim 1, wherein the service response platform engine has:
a system monitor comprising a web-based dashboard;
a service response engine hosting a database of service instances each being able to be viewed from the system monitor;
a load balancer interfacing with the service response engine to access the service instances; and
a worker object factory associated with each service instance.

4. The system according to claim 1, wherein the smart-appliance event-reporting platforms receive manufacturer-specific appliance event messages from respective ones of the smart appliances when the one smart appliance has a failure incident.

5. The system according to claim 4, wherein the service response platform has a machine learning service engine that hosts the database of best corrective actions and progressively learns a best corrective action for each appliance failure incident by:
accessing the database of best corrective actions for each outbound service call request;
performing the triage process to determine a root failure of an appliance associated with the outbound service call request;
based upon the determined root failure:
selecting the relevant trade to be dispatched from the set of trades;
selecting the replacement parts needed; and
estimating the service time;
receiving the service call completion information after the outbound service call request has been performed; and
diagnosing and comparing the received service call completion information within the triage process and storing within the database comparison information to permit improved future handling of incidents based upon that comparison.

6. The system according to claim 1, wherein the enterprise resource platform has a customer and service provider manager:
configured to manage all accounts of the owners, to track all service events, and to output service provider requests;
communicatively connected to the calendars of the service providers and, through this connection, is operable to set the service call within the calendar of any of the service providers; and
communicatively connected to the service response platform engine to exchange information regarding the service call and to have service response platform engine notify the owner that the service call is pending and to send the name of the service provider, the name of the representative to be arriving, and the date and time of the service call.

7. The system according to claim 6, wherein the service response platform engine notifies the owner through at least one of the smartphone and an email.

8. The system according to claim 6, wherein the enterprise resource platform has a dynamic vendor rating engine configured to receive the service provider requests from the customer and service provider manager, to select a set of highest rated service providers located near the location of the owner of the appliance to be serviced, and to rank the service providers based on parameters comprising at least one of service response time, customer input, lowest cost, and fewest callbacks.

9. The system according to claim 6, wherein the customer and service provider manager receives the service call completion information from the service provider, closes the service event, and sends the request to the service response platform engine to notify the owner that the service call has been completed.

10. The system according to claim 9, wherein the customer and service provider manager receives the service call completion information from the service provider through at least one of the smartphone and an email.

11. The system according to claim 1, wherein the service response platform is a server communicatively connected to the Internet.

12. The system according to claim 11, wherein the service response platform provides a direct interface to an owner's smartphone and pushes service calls to the enterprise resource platform.

13. The system according to claim 1, wherein the smart-appliance event-reporting platforms comprise at least one server communicatively connected to the Internet.

14. The system according to claim 1, which further comprises:
a plurality of replacement parts; and
a plurality of service providers each being associated with at least one of the set of trades and each having:
a name;
at least one of the calendars;
at least one service representative; and
a communication device configured to at least one of:
receive the service call; and
send the service call completion information.

15. The system according to claim 14, wherein the plurality of replacement parts is located at a central location.

16. The system according to claim 14, wherein a sub-set of the plurality of replacement parts is located at each of the service providers.

17. A method of handling appliance service events, which comprises:
sending an Internet-based message from a smart appliance to at least one cloud-based smart-appliance event-reporting platform when a failure of the appliance occurs;
forwarding a manufacturer-specific appliance event message from the smart-appliance event-reporting platform to a service response platform;
evaluating the failure of the appliance with the service response platform dependent upon manufacturer-specific appliance event message by:
normalizing the manufacturer-specific appliance event message to determine an outbound service call request having a standardized format;
accessing a database of best corrective actions for the outbound service call request;
performing a triage process to determine a root failure of the appliance and, based upon the determined root failure:
selecting a relevant trade to be dispatched from a set of trades; and
selecting replacement parts needed;
receiving service call completion information after the outbound service call request has been performed; and
diagnosing and comparing the received service call completion information within the triage process and storing within the database comparison information to permit improved future handling of incidents based upon that comparison; and
communicating with the owner through the owner's smartphone to obtain information regarding the appliance to better understand and diagnose the failure;
determining a service action to take based upon the outbound service call request and information from the owner;
when a service call is determined to be required, with an enterprise resource platform:
examining calendars of at least one service provider in the set of trades, and, based upon examination of the calendar, selecting a service provider within the trade and scheduling a physical service call to require a representative of the selected service provider to perform service on the appliance at the location of the owner at a given date and time and to have the representative bring the replacement parts to the location during the service call;
informing service response platform of details regarding the service call to, thereby, notify the owner that the service call is pending and to inform the owner of a name of the service provider, a name of the representative to be arriving, and the given date and time of the service call; and
when a service call is completed:
receiving service call completion information from the service provider at the enterprise resource platform;
closing the service call at the enterprise resource platform;
sending a request from the enterprise resource platform to the service response platform to notify the owner that the service call has been completed; and
sending information about the service call from the enterprise resource platform to the service response platform to be added to the database of best corrective actions for determining at least one of accuracy of a diagnosis the failure of the appliance and to add knowledge to the database for improving future failure diagnoses.
